(19) United States
(12) Patent Application Publication
(10) Pub. No.: US 2002/0074515 A1
(43) Pub. Date: Jun. 20, 2002

(54) Exposure apparatus

(76) Inventor: Taizo Akimoto, Kaisei-machi (JP)

Correspondence Address: SUGHRUE, MION, ZINN MACPEAK & SEAS, PLLC, 2100 Pennsylvania Avenue, N.W., Washington, DC, 20037-3202, US

(21) Appl. No.: 09/749,659

(22) Filed: Dec. 28, 2000

(30) Foreign Application Priority Data
Dec. 28, 1999 (JP) 372924/1999

(51) Int. Cl. G03B 42/08

(52) U.S. Cl. 250/484.4; 427/65

(57) ABSTRACT

A storage phosphor sheet is conveyed in a conveying direction in which test pieces are conveyed by a conveyor unit, the storage phosphor sheet being continuous in the conveying direction and also being greater in width than the test piece in a direction perpendicular to the conveying direction. The storage phosphor sheet being supplied from a roll of phosphor sheet is superposed by a press roller on the test pieces being conveyed. The storage phosphor sheet is cut by a cutter in order to separate the superposed test piece and storage phosphor sheet from the storage phosphor sheet.

### BACKGROUND OF THE INVENTION

1. Field of the Invention

The present invention relates to a method of analysis employing a test piece, such as a microarray, a macroarray, and a deoxyribonucleic acid (DNA) chip, which is employed in DNA analysis, immunological analysis, etc., and more particularly to techniques for detecting energy-emitting substances (typically, radioactive isotopes) which label target substances (which are to be detected) bonded with a large number of detecting substances, disposed and fixed on the test piece.

2. Description of the Related Art

A method of analyzing gene expression by the use of the microarray has been described in a thesis, entitled “Gene Expression Analysis Employing a Microarray” (Experimental Medical Series, Vol. 17, January 1999, pp. 61 to 65).

Techniques, for analyzing gene expression, which employ a test piece such as the microarray, a macroarray, a DNA chip, etc., have recently been known and carried out. In the test piece, as illustrated in FIG. 5, a wide variety of biomolecules (complementary DNA (cDNA), oligo-DNA, other DNAs, PNA, EST, etc.) are disposed and fixed in matrix form as the detecting substances on the surface of the substrate 100, such as membrane, glass, slide glass, and silicon substrates, by a spotter, etc. This test piece is called a microarray, a macroarray, a DNA chip, etc., depending on the substrate type, the substrate size, the number of spots, the spot size, the detecting substance (probe) type, the target substance type, etc.

On the other hand, biomolecules (cDNA, genomic DNA, ribonucleic acid (RNA) such as messenger RNA (mRNA), etc., dNTP, PNA, etc.,) are labeled with a radioactive isotope or fluorescent dye and prepared as target substances to be detected. Then, the detecting substances fixed in matrix form are hybridized with the target substances labeled with the radioactive isotope, etc.

If biomolecules that hybridize each other are contained in the detecting and target substances, both biomolecules are hybridized on the substrate and therefore a labeling substance, such as a radioactive isotope, a fluorescent dye, etc., is fixed through the hybridized biomolecule to the detecting substance having the hybridized biomolecule. On the other hand, the radioactive isotope or fluorescent dye is not fixed to the detecting substance not hybridized. The double circles in FIG. 5 indicate the positions of the hybridized detecting substances on the substrate and schematically show the positions where labeling substances, such as radioactive isotopes, fluorescent dyes, etc., were fixed. Note that FIG. 5 illustrates dots disposed in matrix form so that each dot can be recognized, but in practice, fine dots are disposed with high density and therefore they can be hardly recognized.

In the case where labeling is performed with a radioactive isotope, a method, which employs storage phosphor film on which radiation energy is stored and recorded, is known in order to detect a position on the substrate 100 where the radioactive isotope is present.

The storage phosphor film stores radiation energy when exposed to radiation emitted from a radioactive isotope, and then emits the stored radiation energy as photostimulated luminescent light when irradiated with excitation light such as laser light, etc. That portion of the phosphor film not exposed to radiation does not luminesce. In a typical storage phosphor film, BaFX:Eu²⁺ phosphor particles (where X is a halogen), contained with high density in a binder, are coated on a support member. The storage phosphor film is also known as a radiation-image converting panel employing a stimulatable phosphor.

As shown in FIG. 6, the storage phosphor film 110 is superposed on the surface of the substrate 100 in which radioactive isotopes have been fixed locally as a result of hybridization, and this film 110 is exposed locally to radiation.

As a result, the storage phosphor film 110 is exposed locally to radiation, and luminesces locally when irradiated with excitation light. Therefore, the position of the hybridized biomolecule on the substrate is specified from the position at which the storage phosphor film 110 luminesced, and the type of biomolecule hybridized is specified from the specified position.

The method of detecting radioactive isotopes by the use of the storage phosphor film 110, however, requires the process of accurately positioning the storage phosphor film 110 with respect to the substrate 100 and superposing them. For this reason, the research worker himself has to perform the aforementioned process by hand. Thus, there is a problem that when processing a large number of substrates 100, the process will result in a time-consuming operation.

### SUMMARY OF THE INVENTION

The present invention has been made in view of the problems found in the prior art. Accordingly, it is the primary object of the present invention to provide an exposure apparatus which is capable of effectively processing a large number of test pieces, by automating the process of superposing storage phosphor film on the test pieces.

Note that in the present invention, the application of the test piece is not limited to gene analysis, such as gene expression analysis, a sequence determination for nucleic acid, mutation analysis, polymorphism analysis, etc. In abroad sense, the test piece is also applicable to the analysis of target substances which are bonded selectively with the detecting substances, disposed and fixed in spot form on a substrate, by some reaction.

To achieve the aforementioned object of the present invention, there is provided an exposure apparatus for exposing storage phosphor film to energy emitted from an energy-emitting substance which labels target substances bonded with a large number of detecting substances disposed and fixed on a test piece, the exposure apparatus comprising means for conveying the test piece; means for supplying the storage phosphor film in a conveying direction where the test piece is conveyed by the conveying means, the storage phosphor film being continuous in the conveying direction and also being greater in width than the test piece in a direction perpendicular to the conveying direction; means for superposing the storage phosphor film being supplied by the supplying means on the test piece being conveyed by the conveying means; and means for cutting the storage phosphor film in order to separate the superposed test piece and storage phosphor film from the storage phosphor film.

According to the exposure apparatus of the present invention, the storage phosphor film, which is continuous in the conveying direction of the test piece and also greater in width than the test piece in a direction perpendicular to the conveying direction, is supplied in the conveying direction. As a result, the storage phosphor film can be superposed on the test pieces without positioning the storage phosphor film accurately with respect to the test pieces which are conveyed by the conveying means. The test pieces on which the storage phosphor film was superposed are cut by the cutting means and are taken out one by one.

Thus, according to the exposure apparatus of the present invention, there is no need to position the storage phosphor film accurately with respect to the test pieces. As a result, the process of superposing the storage phosphor film on the test pieces can be automated, and a large number of test pieces can be efficiently processed.

The test piece may be any type if a great number of detecting substances can be disposed, as in a microarray, a macroarray, a DNA chip, etc.

The detecting substance may be cDNA, oligo-DNA, other DNAs, PNA, EST, etc. The detecting substance may be any type if it is employed in an array method. That is, the detecting substances, disposed and fixed on the test piece, are not limited to biomolecules. A great variety of detecting substances can be employed, if they are bonded selectively with target substances by some reaction.

Biomolecules, such as cDNA, genomic DNA, mRNA, totalRNA, other RNAs, dNTP, PNA, etc., are commonly used as the target substance. However, the target substance is not limited to these, and they are only examples.

Therefore, the bond between the target substance and the detecting substance, in addition to hybridization in which a stable double strand is formed between complementary base sequences, includes a specific bond, etc. Note that the case where the target substance and the detecting substance are bonded by some reaction includes, for example, various kinds of affinities.

Note that the storage phosphor film, superposed on the test piece by the aforementioned exposure apparatus, needs to be exposed to the energy emitted from the energy-emitting substance present on the test piece. For this reason, it is preferable that the exposure apparatus be equipped with an exposure stacker which has a plurality of housing portions in which each storage phosphor film superposed on the test piece is left alone for a fixed time. However, there are cases where, when an energy-emitting substance, such as ³²P, etc., which has large energy, is used as a labeling substance, the storage phosphor film on one test piece is exposed to the energy emitted from the energy-emitting substance present on another test piece. Therefore, it is preferred to partition off the housing portions with partition plates which do not transmit the energy emitted from the energy-emitting substance.

For instance, in the case where a radioactive isotope is used as the energy-emitting substance, a partition plate, etc., made of lead, iron, or an alloy of these, are equivalent to the aforementioned partition plate which does not transmit the energy emitted from the energy-emitting substance.

In the aforementioned exposure apparatus, excitation light is irradiated to the storage phosphor film, exposed to the energy emitted from the energy-emitting substance present on the test piece, and the contents of the stored energy are read. When this occurs, the reading step can be efficiently performed, if reading can be performed on the storage phosphor film superposed on the test piece. However, in the case where excitation light is irradiated to the storage phosphor film superposed on the test piece, there is a problem that the excitation light transmitted through the storage phosphor film will be scattered at the test piece and the precision with which the photostimulated luminescent light from the storage phosphor film is read will be reduced. Therefore, in a preferred form of the present invention, the storage phosphor film has a stimulatable phosphor layer, and an absorbing layer which absorbs excitation light irradiated to the stimulatable phosphor layer and also transmits energy emitted from an energy-emitting substance.

In the case of using the aforementioned storage phosphor film, it is first superposed on the test piece so that the absorbing layer faces the test piece. Then, with the test piece and the storage phosphor film superposed, excitation light is irradiated to the storage phosphor film, and the photostimulated luminescent light from the stimulatable phosphor layer is read. When this occurs, excitation light can be prevented from being scattered by the test piece, because the excitation light transmitted through the stimulatable phosphor layer is absorbed by the absorbing layer. In addition, even if the absorbing layer is provided, it has no influence on the exposure of energy to the stimulatable phosphor layer, because the absorbing layer transmits the energy emitted from the energy-emitting substance. The absorbing layer may have a mechanical strength of some magnitude. In this case, the absorbing layer also plays the role of a support member.

### BRIEF DESCRIPTION OF THE DRAWINGS

The present invention will be described in further detail with reference to the accompanying drawings wherein:

FIG. 1 is a schematic diagram showing an exposure apparatus constructed according to a preferred embodiment of the present invention;

FIG. 2 is an enlarged view showing the press roller of the exposure apparatus;

FIG. 3 is a top view showing the storage phosphor film superposed on test pieces by the exposure apparatus;

FIG. 4A is a sectional view showing the storage phosphor film superposed on the test piece;

FIG. 4B is a sectional view showing how the storage phosphor film superposed on the test piece is irradiated with laser light;

FIG. 5 is a schematic perspective view showing the substrate of a conventional test piece; and

FIG. 6 is a schematic perspective view showing how the storage phosphor film superposed on the conventional test piece is exposed to radiation.

### DESCRIPTION OF THE PREFERRED EMBODIMENTS

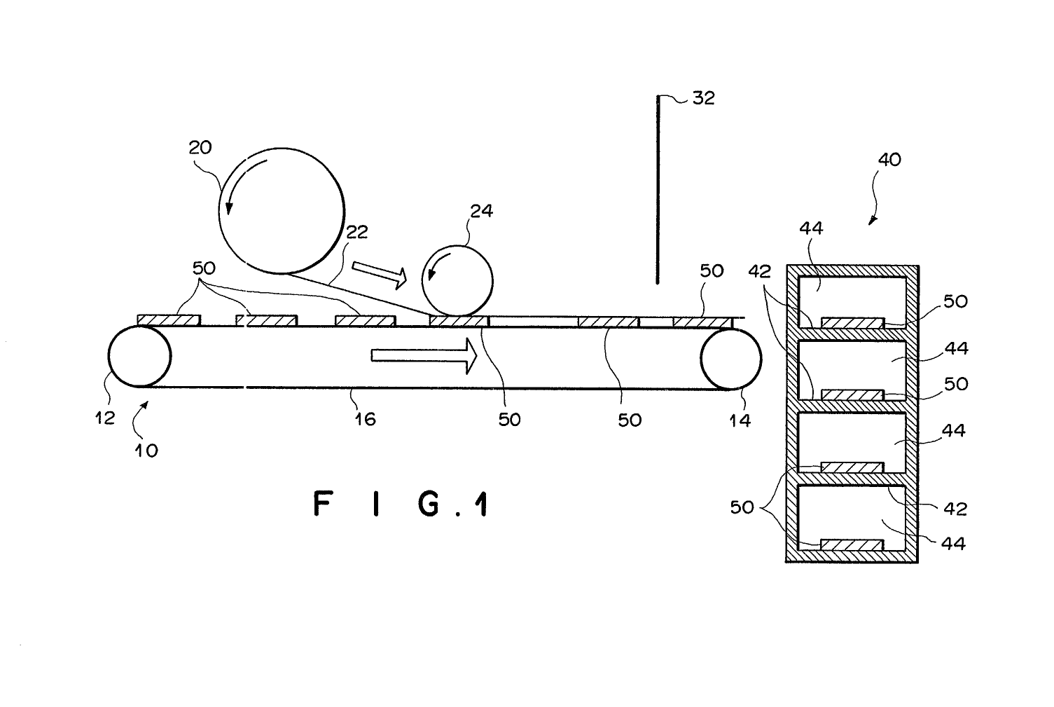

An exposure apparatus according to a preferred embodiment of the present invention will hereinafter be described in detail with reference to FIGS. 1 to 3. As illustrated in FIG. 1, the exposure apparatus in the preferred embodiment is equipped with a conveyor unit 10 for conveying test pieces 50, a phosphor roll 20 provided near the conveyor unit 10, a press roller 24, a cutter 32, and an exposure stacker 40 provided near the terminal end of the conveyor unit 10.

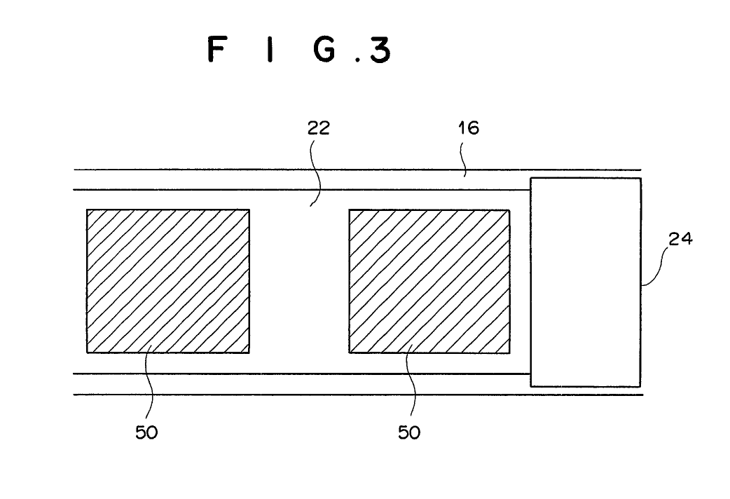

The conveyor unit 10 is equipped with front and rear conveyor rollers 12, 14 rotatably supported at the opposite ends, and a conveyor belt 16 which is driven to rotate by the conveyor rollers 12, 14. The rotating shafts of the conveyor rollers 12, 14 are connected to a control motor (not shown) so that the rotating speed can be controlled. With this arrangement, the test pieces 50 on the conveyor belt 16 are conveyed from the front conveyor roller 12 toward the rear conveyor roller 14 at a predetermined speed. As illustrated in FIG. 3, the conveyor belt 16 is greater in lateral width than the test piece 50 and also greater in lateral width than the storage phosphor film 22.

The phosphor roll 20 is formed by winding storage phosphor film 22 in roll form. If the phosphor roll 20 is rotated on its axis of rotation to unwind the storage phosphor film 22 from the roll 20, the storage phosphor film 22 is supplied in the direction in which the test pieces 50 are conveyed. Therefore, in the preferred embodiment, the phosphor roll 20 is equivalent to a means of supplying the storage phosphor film 22 in the conveying direction.

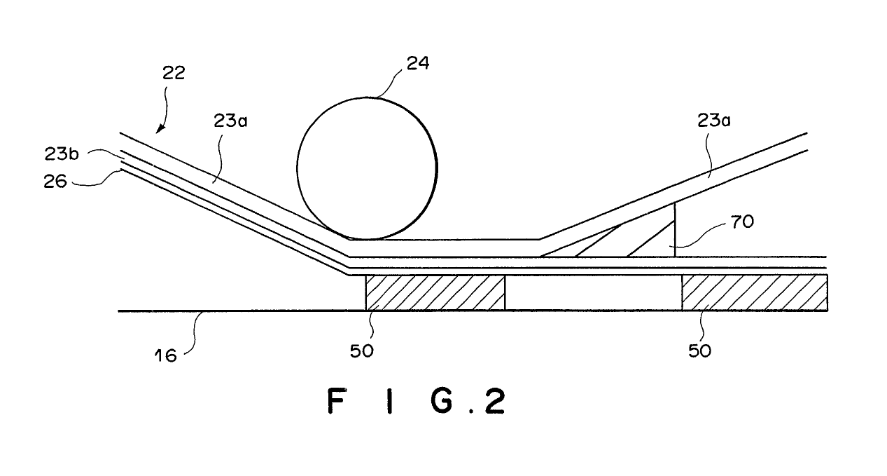

The storage phosphor film 22 is constructed of a temporary support member 23a, a phosphor layer 23b, and a scattering prevention layer 26, as shown in FIG. 2. The temporary support member 23a is provided for protecting the phosphor layer 23b when external force, etc., is exerted on the storage phosphor film 22. The surface of the temporary support member 23a that faces the phosphor layer 23b is coated with a release agent so that the temporary support member 23a can be readily released from the phosphor layer 23b. The material of the temporary support member 23a employs thick polyethyrene terephthalate (PET) film, etc. The phosphor layer 23b is constructed of BaFX:Eu²⁺ phosphor particles (where X is a halogen) bonded and held with an organic polymer (binder). The scattering prevention layer 26 is provided for absorbing excitation light, irradiated to the phosphor layer 23b when reading radiation, and transmitted through the phosphor layer 23b. Since the wavelength of excitation light varies depending on the phosphor particle type, the phosphor layer 23b is equipped with a light absorbing layer which can absorb light in the wavelength region of excitation light, in accordance with the phosphor particle type. The scattering prevention layer 26 also has the property of transmitting radiation emitted from radioactive isotopes that label target substances present on the test piece 50.

The press roller 24 performs a process of superposing and sticking the aforementioned storage phosphor film 22 on the test pieces 50. For this reason, the press roller 24 is formed into the shape of a cylinder having a greater width than that of the test piece 50 so that the storage phosphor film 22 can be stuck on the entire test piece 50. This renders it possible to press the entire storage phosphor film 22 against the test piece 50.

Near the press roller 24, release means 70 is provided for releasing the temporary support member 23a from the storage phosphor film 22 superposed on the test pieces 50, as shown in FIG. 2. The release means 70 is interposed like a wedge between the temporary support member 23a and the phosphor film 23b so that the temporary support member 23a is released from the storage phosphor film 22 being sent. The released temporary support member 23a is wound and collected by a take-up roller (not shown).

Note that an erasure light source, for irradiating visible light to the entire surface of the storage phosphor film 22, may be provided between the phosphor roll 20 and the press roller 24 in order to erase noise, etc., stored and recorded on the film 22.

To cut the storage phosphor film 22, a cutter 32 is disposed between the press roller 24 and the rear conveyor roller 14. This cutter 32 is guided by a guide member (not shown) so that it is movable in an up-and-down direction.

The aforementioned exposure stacker 40 is disposed near the read end of the conveyor unit 10. The exposure stacker 40 has a plurality of housing portions 44 for housing the test pieces 50 on which the storage phosphor film 22 was superposed. Partition plates 42 for partitioning off the housing portions 44 are made of lead, and each partition plate 42 is used for absorbing radiation emitted from the radioactive isotopes fixed on the test pieces 50, housed in the housing portions 44 adjacent to the partition plate 42.

Now, the operation of the exposure apparatus mentioned above will be described in detail.

A plurality of test pieces 50 are first set with predetermined spaces on the conveyor belt 16 on the side of the front conveyor roller 12. Note that each test piece 50 which is set on the conveyor belt 16 is made as follows: That is, an extremely large number of detecting substances are disposed and fixed on a substrate such as a membrane, etc., and are hybridized with target substances labeled with radioactive isotopes. The target substances not hybridized are washed off the substrate, and the substrate is dried.

Next, part of the storage phosphor film 22 is unwound from the fluorescence-substance roll 20, and the leading end of the unwound storage phosphor film 22 is pulled out to the rear side of the press roller 24. At part of the leading end of the storage phosphor film 22, the temporary support member 23a is released from the phosphor layer 23b, and as shown in FIG. 2, the release means 70 is fitted between the temporary support member 23a and the phosphor layer 23b. The leading end of the temporary support member 23a is fitted to the above-mentioned take-up roller.

If preparation is finished, the front and rear conveyor rollers 12 and 14 rotate and therefore the conveyor belt 16 is rotated. If the conveyor belt 16 is rotated, the test pieces 50 on the conveyor belt 16 are conveyed from the front conveyor roller 12 toward the rear conveyor roller 14. If the test piece 50 is conveyed under the press roller 24, the phosphor roll 20 and the press roller 24 begin to rotate. If the phosphor roll 20 rotates, the storage phosphor film 22 is unwound from the roll 20 and supplied in the aforementioned conveying direction at a speed corresponding to the conveying speed. The supplied storage phosphor film 22 is pressed against the test piece 50 by the press roller 24. As a result, the storage phosphor film 22 is superposed and stuck on the test pieces 50 in sequence.

When the storage phosphor film 22 is superposed on the test pieces 50, the storage phosphor film 22 can be superposed on the test pieces 50 without positioning the lateral position of the test pieces 50 accurately with respect to the storage phosphor film 22, because the storage phosphor film 22 is greater in width than the test piece 50. In addition, there is no need to position the test pieces 50 accurately in the conveying direction, since the storage phosphor film 22 is supplied as a sheet of storage phosphor film continuous in the conveying direction.

As illustrated in FIG. 2, the temporary support member 23a is released by the release means 70 from the storage phosphor film 22, superposed and stuck on the test pieces 50 by the press roller 24. The test pieces 50, superposed and stuck on the storage phosphor film 22 from which the temporary support member 23a was released, are further conveyed by the conveyor belt 16. Thereafter, the storage phosphor film 22 is cut by the cutter 32, and the test pieces 50, on which the storage phosphor film 50 was superposed, are separated from one another.

The separated test pieces 50 are respectively housed in the housing portions 44 of the exposure stacker 40 and are left alone for a fixed time. If each of the test pieces 50 is left alone for a fixed time, the radiation energy from the radioactive isotopes labeling the target substance remaining on the test piece 50 is stored on the storage phosphor film 22.

The aforementioned steps are performed in sequence for each test piece 50 set on the conveyor belt 16. When this occurs, the storage phosphor film 22 is supplied continuously from the phosphor roll 20 in the conveying direction and therefore the test pieces 50 set with predetermined spaces on the conveyor belt 16 can be continuously processed. The predetermined space may be any space as long as the test pieces are spaced to such a degree that the test piece 50 is not cut accidentally when cutting the storage phosphor film 22 with the cutter 32.

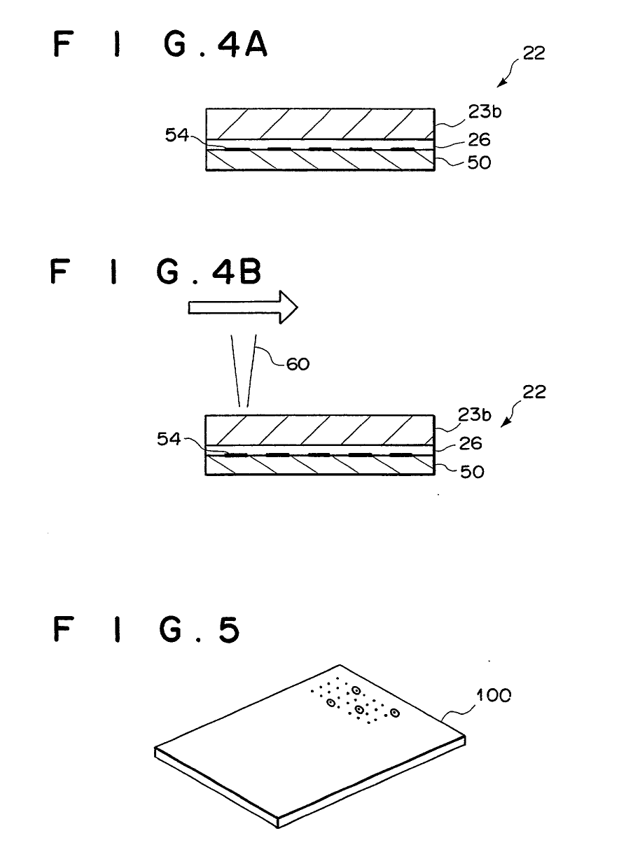

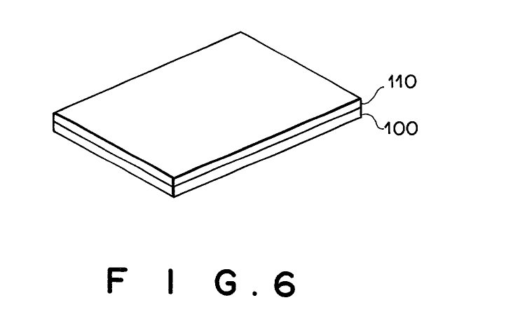

The contents, stored and recorded on the storage phosphor film 22 exposed to radiation by the aforementioned exposure apparatus, are read in the following steps. First, the test piece 50 on which the storage phosphor film 22 was superposed is taken out from the housing portion 44. As shown in FIG. 4A, the storage phosphor film 22, superposed on the test piece 50 taken out, consists of only the phosphor layer 23b and the scattering prevention layer 26, because the temporary support member 23a has been removed. Therefore, the surface of the phosphor layer 23b is exposed, and with the test piece 50 and the storage phosphor film stuck as shown in FIG. 4B, the surface of the phosphor layer 23b is irradiated with laser light 60. Next, the photostimulated luminescent light, emitted from the detection substances 54 on the test piece 50 where the radiation energy has been stored, is detected. The apparatus for reading the photostimulated luminescent light can employ various kinds of apparatuses known (see Japanese Unexamined Patent Publication No. 10(1998)-3134, etc.). Based on both the position data of the photostimulated luminescent light detected and the position and type data of the detection substances disposed on the test piece, the positions on the test piece 50 where the detection substances were hybridized with the target substances are judged.

In the exposure apparatus according to the preferred embodiment, as has been described in detail, the lateral width of the storage phosphor film 22 that are supplied from the phosphor roll 20 is set greater than that of the test piece 50, and the storage phosphor film 22 is also supplied as a sheet of film continuous in the conveying direction. Thus, there is no necessity for accurately positioning the storage phosphor film 22 and the test pieces 50, and the step of superposing the storage phosphor film 22 on the test pieces 50 can be automated. In addition, a plurality of test pieces can be set simultaneously on the conveyor belt 16 and can be continuously processed, because the storage phosphor film 22 is continuous in the conveying direction.

Besides, the temporary support member 23a is removed from the storage phosphor film 22 stuck on the test pieces 50. Therefore, with the storage phosphor film 22 stuck on the test pieces 50, the photostimulated luminescent light from the storage phosphor film 22 can be read by irradiating excitation light to the storage phosphor film 22.

Furthermore, although, in the preferred embodiment, a membrane which is a scattering body is used as the substrate for the test pieces 50, the scattering prevention layer 26 absorbs excitation light, irradiated to the storage phosphor film 22, and transmitted through the phosphor layer 23b. Therefore, the influence of light scattering due to the membrane can be prevented, and image resolution can be enhanced.

While, in the preferred embodiment, the storage phosphor film 22 with the temporary support member 23a has been used, storage phosphor film having no temporary support member can be used. In this case, the apparatus can be rendered structurally simpler, because the need to dispose the release means that releases the temporary support member 23a from the storage phosphor film 22, as in the preferred embodiment, is eliminated. In addition, it is a matter of course that the exposure apparatus of the present invention is also applicable to storage phosphor film having a support member.

Although, in the preferred embodiment, the storage phosphor film 22 has been superposed and stuck on the test pieces 50 by the press roller 24, the present invention is not to be limited to this. Instead, the storage phosphor film 22 may be stuck on the test pieces 50 by pressing the phosphor roll itself against the test pieces 50 with a predetermined pressing force.

In addition, in the case where the membrane is used as the substrate of the test pieces, and laser light (excitation light) is irradiated to the storage phosphor film stuck on the test pieces, it is preferable to use a colored membrane so that it can absorb the laser light, irradiated to the storage phosphor film, and transmitted through the storage phosphor film. This prevents the scattering of laser light, transmitted through the storage phosphor film, due to the membrane, and enhances the precision with which photostimulated fluorescence is read.

Although, in the preferred embodiment, no adhesive is used for superposing and fixing the test pieces 50 and the storage phosphor film 22, an adhesive may be used in firmly sticking both.

While the present invention has been described with reference to the preferred embodiment thereof, the invention is not to be limited to the details given herein, but may be modified within the scope of the invention hereinafter claimed.

In addition, all of the contents of Japanese Patent Application No. 11(1999)-372924 are incorporated into this specification by reference.

What is claimed is:

1. An exposure apparatus for exposing storage phosphor film to energy emitted from an energy-emitting substance which labels target substances bonded with a large number of detecting substances disposed and fixed on a test piece, said exposure apparatus comprising:
means for conveying said test piece;
means for supplying said storage phosphor film in a conveying direction where said test piece is conveyed by said conveying means, said storage phosphor film being continuous in said conveying direction and also being greater in width than said test piece in a direction perpendicular to said conveying direction;
means for superposing said storage phosphor film being supplied by said supplying means on said test piece being conveyed by said conveying means; and
means for cutting said storage phosphor film in order to separate said superposed test piece and storage phosphor film from said storage phosphor film.

2. The exposure apparatus as set forth in claim 1, further comprising an exposure stacker equipped with a plurality of housing portions for respectively housing said cut test pieces having said storage phosphor film superposed thereon, said housing portions being partitioned off by partition plates which do not transmit said energy emitted from said energy-emitting substance.

3. Storage-type phosphor film comprising:
a stimulatable phosphor layer; and
an absorbing layer which absorbs excitation light irradiated to said stimulatable phosphor layer and also transmits energy emitted from an energy-emitting substance.
